(19) United States
(12) Patent Application Publication
(10) Pub. No.: US 2012/0038165 A1
(43) Pub. Date: Feb. 16, 2012

(54) SYSTEM AND METHOD FOR GENERATING POWER IN A DAM

(76) Inventor: Rene Carlos, College Park, MD (US)

(21) Appl. No.: 12/854,707

(22) Filed: Aug. 11, 2010

(51) Int. Cl. F03B 13/08

(52) U.S. Cl. 290/54

(57) ABSTRACT

A system and method for generating power in a dam are provided. Water passing through a water channel is directed into an exit channel. The water channel converges with the exit channel. Exhaust gases from a heat engine are expelled into the exit channel. The exhaust gases from the heat engine are then used to pull the water, decreasing a pressure of the exit channel. The decreased pressure causes the dam to act as though the head of dammed water were higher than the head mechanically is.

### BACKGROUND

1. Field

The present invention relates to a method and system for generating power in a dam. More specifically, the method and system combines a heat engine, such as a gas turbine, and a water turbine to create a joint power generation system that can productively operate in areas where traditional hydroelectric dams cannot or improve the performance of existing dams, such as older dams that need repowering.

2. Description of the Related Art

In power generation systems, gas turbines are known that extract energy from a combustible fuel. For instance, a gas turbine generally has an upstream multi-stage compressor that compresses air flowing into the engine, a combustion chamber where fuel (typically gas) is ignited and combusted with the compressed air, and a turbine that harnesses the energy from the flow of the combustion gases. The combusted gas is then expelled from the rear of the engine. The rotating turbine drives an electric generator that converts mechanical energy into electrical energy, and thus creates electricity.

Hydroelectric power generation systems are also known. The energy in these systems generally comes from the potential energy of dammed water due to gravity driving a water turbine that, in turn, drives a generator. The power generated by the system depends on the difference in height between the water's source and water outflow (head) and the volume of water that runs through the water turbine. As with the gas turbine, the water turbine may be used to drive a generator and create electricity.

### SUMMARY

Certain embodiments of the present invention may provide solutions to the problems and needs in the art that have not yet been fully solved by currently available gas turbine and water turbine technologies. For example, certain embodiments of the present invention provide a method and system that combines a heat engine and a water turbine to create a joint power generation system that can productively operate in areas where traditional hydroelectric dams cannot or improve the performance of existing dams.

In one embodiment of the present invention, a system includes an exit channel configured to receive a flow of water and a flow of exhaust gases. The system also includes a water channel configured to direct the flow of water into the exit channel and a heat engine configured to expel high velocity exhaust gases into the exit channel. The exhaust gases from the heat engine pull the water, decreasing a pressure in the exit channel.

In another embodiment of the present invention, a system includes an exit channel configured to receive a flow of water and a flow of exhaust gases. The system also includes a water turbine configured to be rotated by a flow of water through a penstock. The penstock is supplied with water by a water intake and the penstock is configured to direct the water into the exit channel. The system further includes a heat engine configured to expel high velocity exhaust gases into the exit channel. The exhaust gases from the heat engine pull the water, decreasing pressure in the exit channel. This decrease in pressure causes the dam to act as though the head of dammed water were higher than the head mechanically is.

In yet another embodiment of the present invention, a method includes directing water passing through a water channel into an exit channel. The water channel converges with the exit channel. The method also includes expelling exhaust gases from a heat engine into the exit channel. The method further includes using the exhaust gases from the heat engine to pull the water, decreasing pressure in the exit channel. This decrease in pressure causes the dam to act as though a head of dammed water were higher than the head mechanically is.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a side view of a dam system combining gas turbine power generation and hydroelectric power generation, according to some embodiments of the present invention.

FIG. 2 is a graph illustrating the level of Lake Mead in feet over mean sea level per year after the Hoover Dam's construction.

FIG. 3 is a top view of a gas turbine and a water turbine, according to some embodiments of the present invention.

FIG. 4 illustrates a Brayton cycle heat engine, according to some embodiments of the present invention.

FIG. 5 illustrates a gas turbine implementation of a Brayton cycle heat engine, according to some embodiments of the present invention.

FIG. 6 illustrates a dam controller, according to some embodiments of the present invention.

FIG. 7 illustrates a side view of a gas turbine and a water turbine where the water turbine has a horizontal shaft, according to some embodiments of the present invention.

FIG. 8 is a flow diagram illustrating a method for combining a Brayton cycle heat engine and a water turbine, according to some embodiments of the present invention.

### DETAILED DESCRIPTION

It will be readily understood that the components of various embodiments of the present invention, as generally described and illustrated in the figures herein, may be arranged and designed in a wide variety of different configurations. Thus, the following more detailed description of the embodiments of a system and method of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

In some embodiments of the present invention, power is generated in a dam by exploiting a novel, synergistic combination of a Brayton cycle heat engine and a water turbine. Water passing through the water turbine is directed into a water channel that converges with an exit channel for the Brayton cycle heat engine. Exhaust gases from the Brayton cycle heat engine are expelled into the exit channel, where the exhaust gases pull the water, decreasing pressure in the exit channel. This decrease in pressure causes the dam to act as though the head of dammed water were higher than the head mechanically is.

Existing industrial gas turbine power generation systems may have certain disadvantages. For instance, such systems may suffer from constrained fuel supplies and cause varying amounts of pollution, depending largely on the fuel that is consumed. Another potential drawback to gas turbine power generation systems is that on an industrial scale, it generally takes a significant amount of time and energy to spin up the compressor. This reduces the desirability of, and ability to, generate on-demand power. For instance, it may be desirable to activate certain power systems to generate on-demand power in order to satisfy a peak load on the system. Such a peak load typically occurs around 3:00 pm, particularly during summer months when much of the power demand for air conditioning occurs.

With respect to hydroelectric power generation, such systems are well adapted to providing on-demand power, and have the further benefit of creating far less pollution than many other power generation systems, such as coal-fired power plants. However, hydroelectric power systems are only as efficient as the supply of water that is dammed. Many river sites inherently have a low head due to the natural water supply, making many such sites unattractive for dams. Further, at existing sites, if water levels drop due to drought, for instance, it may not be possible to create as much power through the system due to decreased head and a desire not to release so much of the water as to further affect the hydroelectric plant's operation.

Some embodiments of the present invention are able to overcome these disadvantages by combining aspects of a heat engine and a water turbine. Some embodiments generate shaft power (e.g., for electrical power generation), and potentially some thermal/steam power, with greater effective output than via a heat engine alone (e.g., via combustion of natural gas, oil, ethanol, or any other fuel that serves as a heat source), and with more development potential (i.e., more technologically feasible and economically practical sites) than via hydropower alone. Embodiments of the present invention achieve these advantages by combining at least one pairing of a heat engine and a water turbine in a dam. Some embodiments of the present invention may operate on dam sites where an insufficient water head or supply exists to create an economically practical hydropower dam. Additionally, existing dams may be augmented with embodiments of the present invention to boost power output.

By allowing more hydroelectric dams, available power increases on larger (grid) scales. In addition, this power is highly dispatchable (time-variable under active command), which can be a valuable secondary attribute that not all generation types possess. Some embodiments also drive the lower pressure stages of a multi-stage compressor of the heat engine by taking advantage of head from the dam. Another secondary benefit of some embodiments is containment of some heat engine exhaust in output water.

The commercial potential of such a system is high. Output power is in high demand, especially if dispatchable. Fuel resources are constrained, while water sites (inherently dispatchable) of moderate head are only marginally economical, at best, with current technology. Heat engines, being limited by high temperatures, may either be simplified, or have their efficiency and/or output raised by some embodiments of the present invention.

A heat engine takes advantage of heat energy to perform mechanical work. The heat engine may be any form of heat engine that is capable of expelling high velocity exhaust and generates heat from a heat source. One example of a heat engine is a Brayton cycle heat engine. A Brayton cycle heat engine may be an internal combustion engine such as a gas turbine engine or a piston engine, or an external combustion engine such as a steam engine. The engine may take any desired form and is not limited by this disclosure in any way. The heat source of the heat engine may be provided by various fuels in some embodiments. For instance, some embodiments may use gases (such as natural gas), liquids (such as petroleum fuels), sufficiently-pulverized coal, biomass, slurries, suspensions, radioisotopes, solar absorbers, geothermal transfer fluids, or any other fuel suitable for driving a heat engine. Due to an advanced pipeline infrastructure at least in the United States, natural gas may be more economical and/or cleaner than many of the other fuel alternatives for U.S. implementations at many existing or potential dam sites.

The water turbine may be any type that is desired and may have any practical shaft orientation that makes sense for the given dam architecture and the type of water turbine that is used. For example, the water turbine may be a reaction turbine such as a Francis or a Kaplan turbine, an impulse turbine such as a Pelton or Turgo turbine, or any other turbine that makes sense based on the dam site and architecture. Generally, shaft orientation tends to be vertical or horizontal, but any suitable orientation can be used, depending on a dam's design.

Reaction turbines may make more sense for low head environments and impulse turbines may make more sense for higher head environments. For instance, Kaplan turbines generally have a typical head range between 2 and 40 meters, Francis turbines generally have a typical head range between 10 and 350 meters, Turgo turbines generally have a typical head range between 50 and 250 meters, and Pelton turbines generally have a typical head range between 50 and 1300 meters. However, embodiments of the present invention are not limited to these ranges or to the aforementioned turbine types.

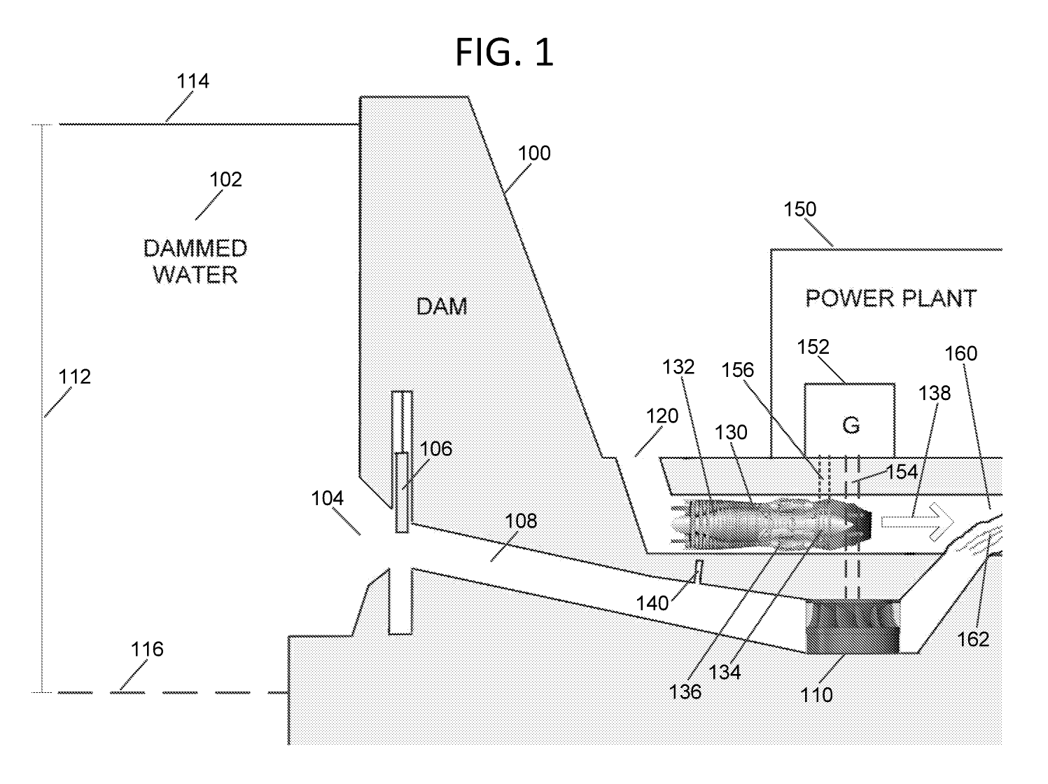

FIG. 1 is a side view of a system combining gas power generation and hydroelectric power generation, according to some embodiments of the present invention. The depicted system includes a dam 100 holding back dammed water 102. Water enters dam 100 via a water intake 104 and the flow of the water is controlled by control gate 106. Control gate 106 may be raised or lowered to increase, decrease, or completely restrict water flow to a penstock 108. While penstock 108 is depicted as a water channel here, a pipe, a conduit, or any other suitable water channel or water piping mechanism may be used. After passing control gate 106, the water enters penstock 108 that supplies the water to a water turbine 110. Dammed water 102 has a certain head 112, which is the difference in height between the level of water 114 before the dam 100 and the level of water 116 after the dam 100 (i.e., water that has passed through the dam and is now downstream in the river). However, in some embodiments, the difference in height may be anywhere and not necessarily near the top of the dam.

The system also includes an air intake 120 that supplies air to gas turbine 130. While gas turbine 130 is shown in this embodiment, any suitable heat engine may be used. Gas turbine 130 may be positioned such that air entering air intake 120 can only pass through gas turbine 130 and has no path around gas turbine 130. In this embodiment, compressor water channel 140 provides water that powers lower pressure stages of a compressor 132 of gas turbine 130 via a direct drive shaft (not shown). The lower pressure stages of compressor 132 include fewer than all of the fan stages that make up the compressor. The direct drive shaft uses gravity-driven potential energy from head 112 of dammed water 102 and is driven by water running through compressor water channel 140. Keeping the first stages of compressor 132 running may be advantageous over existing heat engine systems since compressor 132 can be spun up to generate power more quickly, and with less energy cost, than a typical gas turbine. This may allow gas turbine 130 to generate on-demand power more quickly, efficiently and effectively than existing gas turbines.

In some other embodiments, in lieu of a direct drive shaft, water from compressor water channel 140 runs through a second water turbine that powers another generator. In yet other embodiments, water from compressor water channel 140 may drive external blades that power fans of the first stage of compressor 132. Still other embodiments do not have such a water-powered compressor drive mechanism and may not realize the dispatchability that a water-powered compressor drive mechanism may achieve.

In some embodiments, the power output of gas turbine 130 may be boosted by injecting water into warmer stages of compressor 132 and/or into, around, and/or inside a turbine 134. This serves the dual purpose of cooling gas turbine 130 and providing a higher mass flow of air to a combustion chamber 136. Naturally, the injected water should not be of such a volume as to impede performance of gas turbine 130. In some embodiments, water may be misted into the flow of exhaust gases 138 to reduce the noise generated by gas turbine 130. While there will be some sound damping effect by directing exhaust gases 138 into water 162 that has passed through water turbine 110 in exit channel 160, a far larger sound damping effect is created by adding a water mist to the system.

A power plant 150 houses a generator complex 152 that generates power for the system. Generator complex 152 may include a single generator or multiple generators. Water turbine 110 and gas turbine 130 are operably connected to generator complex 152 via shafts 154 and 156, respectively. Shafts 154 and 156 may drive the same generator or different generators, depending on the desired implementation. The rotation of water turbine 110 and gas turbine 130 rotates shafts 154 and 156, respectively. In some embodiments, as shafts 154 and 156 turn, a series of magnets inside generator complex 152 also turn. The magnets in such generators generally rotate past copper coils, producing current by generating moving electrons. However, some users may simply accept shaft work in other embodiments. In this embodiment, it is possible to operate water turbine 110 alone, gas turbine 130 alone, or both, at any given time to achieve the desired power output. To further facilitate this selective operation, a gate mechanism (not shown) may be included in some embodiments to prevent water spray from water entering exit channel 160 from heading up exit channel 160 towards gas turbine 130 when gas turbine 130 is not operating.

Exhaust gases 138 from gas turbine 130 accelerate water 162 in exit channel 160 that has passed through water turbine 110. Accelerating the water in this fashion takes advantage of the Bernoulli principle and the Coanda effect to draw water into water intake 104 and through penstock 108 with greater pressure. The Bernoulli principle states that an increase in speed of a fluid occurs simultaneously with a decrease in pressure. The Coanda effect is the tendency of a rapidly moving fluid jet to be attracted to a nearby surface. In the context of these principles, a “fluid” may be a gas such as air.

The Bernoulli principle and the Coanda effect cause exhaust gases 138 to pull the water, decreasing pressure in the exit channel exit channel 160 and increasing a flow of water 162. Further, there is some entrainment of the water stream due to viscous forces. This lower pressure environment in exit channel 160 causes the system to behave as though head 112 of dammed water 102 is greater than it mechanically is. Specifically, the system behaves as though the exit for the water is lower than it mechanically is.

While a single heat engine and water turbine are depicted in FIG. 1, on an industrial scale, multiple heat engine/water turbine pairings could be utilized to generate increased power output, limited only by the site and size of the dam. Further, it is possible to have multiple heat engines for a single water turbine, multiple water turbines for a single heat engine, or multiple heat engines for multiple water turbines. Water flowing from the turbine(s) and exhaust gas from the heat engine(s) may be funneled into a common exit channel in such embodiments. Further, the heat engines may be in the same channel or different channels. The water turbines may also be in the same water channel or different water channels.

Also, the interaction between hot exhaust gases and water flowing in the exit channel generates steam. In some embodiments, the steam can be harnessed for a variety of uses. For instance, steam may be recondensed on-site for injection into the heat engine to cool the heat engine and/or generate more power. Another potential use of the steam is to send the steam to off-site users for use in buildings, in equipment, on raw material, etc., to moderate temperatures at low pressure. Yet another use of the steam is to drive a generator and generate further power.

An advantage of some embodiments of the present invention is that dams can be economically built in places where building dams with current technology is not practically feasible due to insufficient water supply and/or inability to generate sufficient head. The ratio of power generated by the hydroelectric power generation portion and the gas turbine portion will vary based on the amount of water that is actually available and the demand for power from the system. For instance, a section of a river with a relatively low amount of water may rely more heavily on gas turbine 130 for power generation. Conversely, an area with a relatively high amount of water may rely more heavily on water turbine 110 for power generation.

Another advantage is that existing dams may be retooled to generate more power. Per the above, embodiments of the present invention cause the dam system to behave as though the head is larger than it mechanically is, allowing for increased power output from water turbines in a dam. The addition of gas turbines to the dam also adds more power sources that increase the potential power output.

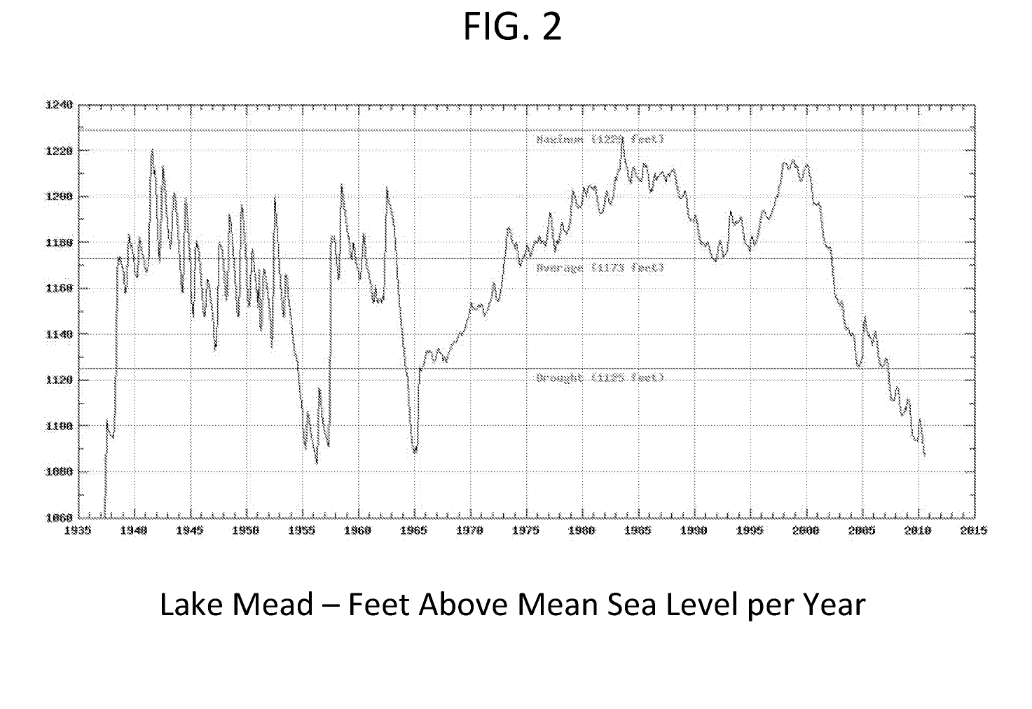

Further, some embodiments of the present invention allow existing dams to perform better where water levels have dropped. A recent example of such a drop in head is Lake Mead. Lake Mead, which was created by the Hoover Dam, has fallen to levels near historical lows and has been steadily declining since approximately the year 2000 (see FIG. 2). A system such as the embodiment depicted in FIG. 1 and described above may be able to increase the power generation capabilities of Hoover Dam.

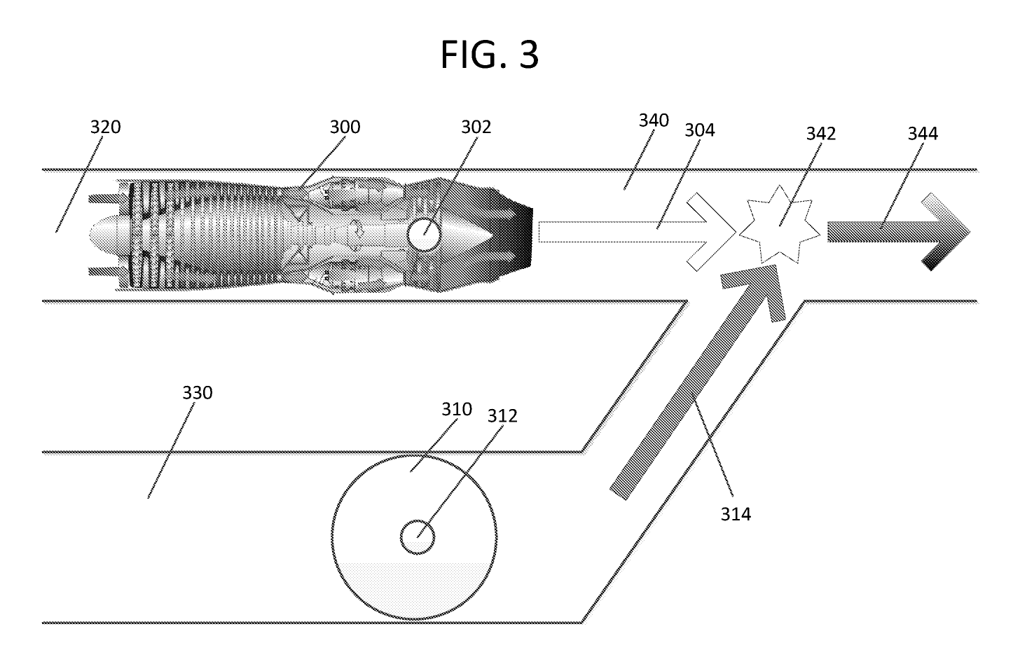

FIG. 3 is a top view of a gas turbine 300 and a water turbine 310, according to some embodiments of the present invention. In some embodiments, the arrangement illustrated in FIG. 3 may be present in the system illustrated in FIG. 1. In systems where a water turbine has a vertical shaft, it may not be feasible or practical to position a gas turbine directly above or below the water turbine. Accordingly, in FIG. 3, gas turbine 300 is positioned at least horizontally apart from water turbine 310. Also, it is possible, and perhaps desirable due to dam layout constraints, for gas turbine 300 and water turbine 310 to have different vertical positions in addition to horizontal positions. However, in embodiments where the shaft of the water turbine is not vertical, it may be possible for the water turbine and the gas turbine to be positioned above one another.

In FIG. 3, gas turbine 300 is supplied with air via air intake 320 and water turbine 310 is provided with flowing water via penstock 330. Rotation of the turbine in gas turbine 300 causes the rotation of shaft 302, which drives a generator. Similarly, rotation of water turbine 310 causes the rotation of shaft 312, which drives a generator.

Exhaust gases 304 from gas turbine 300 and water 314 that passed through water turbine 310 are driven into exit channel 340. There, exhaust gases 304 from gas turbine 300 and water 314 meet at intersection 342. The faster moving exhaust gases 304 pull the water, decreasing pressure in exit channel 340. This decrease in pressure causes the system to behave as though the head were higher than it mechanically is by simulating a lower exit for the water.

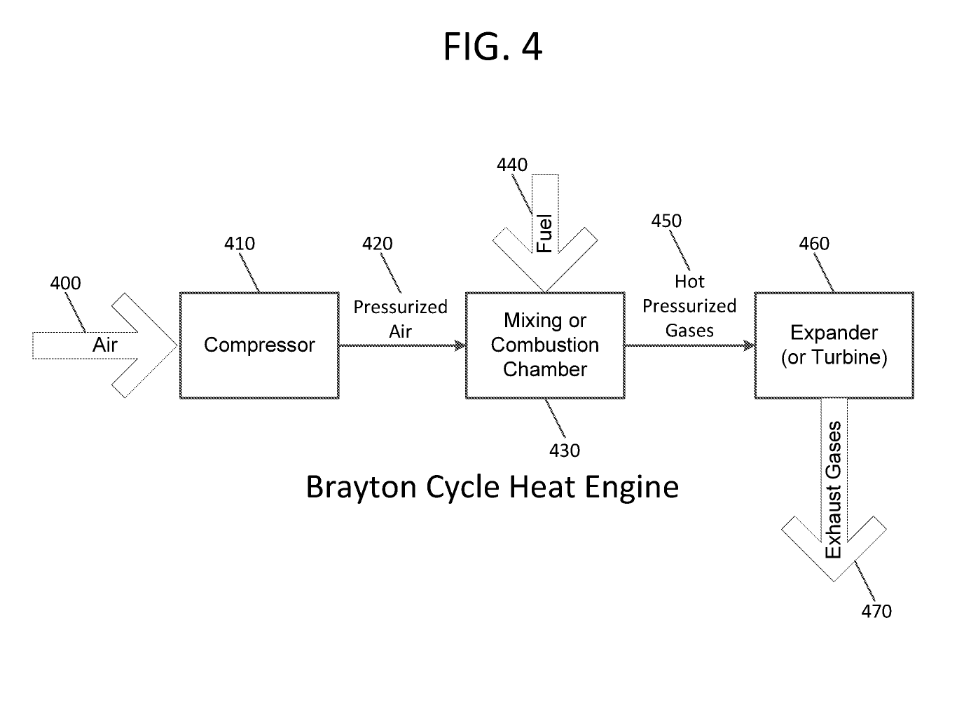

FIG. 4 illustrates a Brayton cycle heat engine, according to some embodiments of the present invention. In some embodiments, the depicted Brayton cycle heat engine of FIG. 4 may be gas turbines 130 and 300 of FIGS. 1 and 3, respectively. The Brayton cycle heat engine takes in outside air 400, or a supplied gas such as oxygen, via a compressor 410. Compressor 410 compresses outside air 400 and passes pressurized air 420 into a mixing chamber (or combustion chamber) 430. Mixing chamber 430 combines pressurized air 420 with a fuel mixture 440 and ignites the combination. This creates hot pressurized gases 450 that are fed into an expander (or turbine) 460. Expander 460 allows hot pressurized gases 450 to expand and do work, such as driving a piston or turning a turbine. Thereafter, expander 460 releases exhaust gases 470. Thus, the inputs into the Brayton cycle heat engine are outside air 400 and fuel 440, and the output is exhaust gases 470.

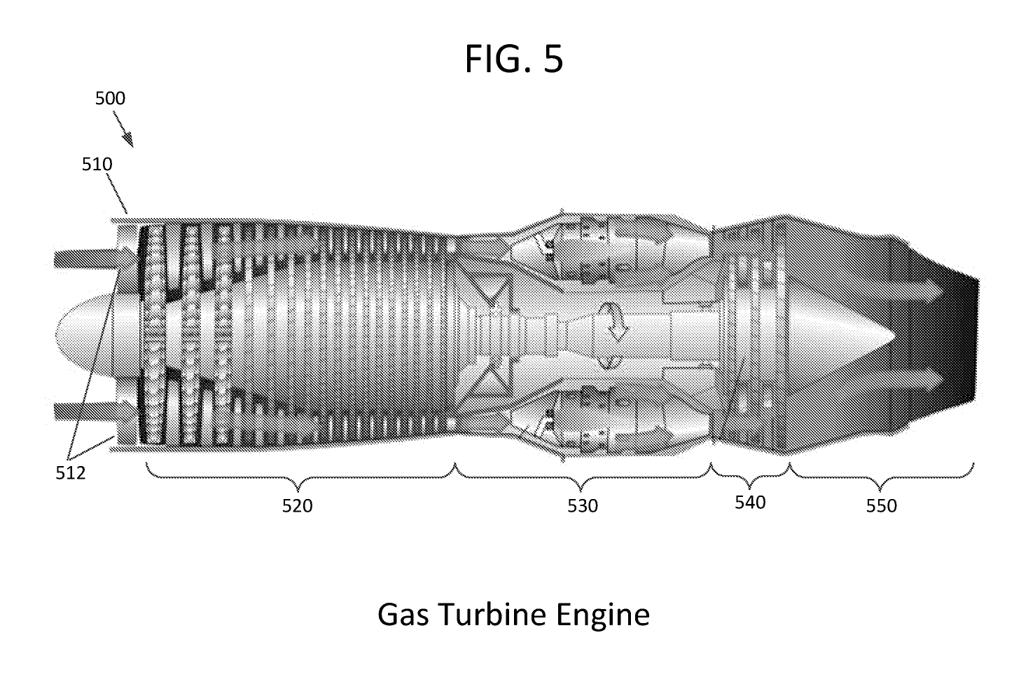

FIG. 5 illustrates a gas turbine 500 implementation of a Brayton cycle heat engine, according to some embodiments of the present invention. In some embodiments, the depicted gas turbine of FIG. 5 may be gas turbines 130 and 300 of FIGS. 1 and 3, respectively. Gas turbine 500 has an intake 510 that takes in air via air inlets 512. The air then enters a compressor 520 that includes a series of fan stages. Each fan stage from left to right compresses the air more and more until a desired air compression level is achieved.

Compressed air from compressor 520 is then directed into combustion chamber 530, which combines the compressed air from compressor 520 with a fuel, such as petroleum fuels or natural gas, and ignites the mixture. This creates a large amount of heat and adds energy to the system. In fact, generally speaking, the hotter the temperature and the higher the pressure that gas turbine 500 can tolerate, the more power that the engine can generate. This generally depends on the temperature and pressure that the gas turbine's materials can tolerate.

Combustion in combustion chamber 530 creates high-temperature, high-pressure exhaust gases that are then directed into turbine 540 by nozzle 550. The hot, high-pressure gases rotate turbine 540 and create mechanical energy that can be harnessed for driving a generator shaft and generating power, for example. The exhaust gases then exit nozzle 550 and leave gas turbine 500 at high velocity. While nozzle 550 depicted in this embodiment is a fork nozzle, other nozzle types may be used. For example, in many embodiments, a sleeve-type ejector nozzle is used instead of a fork nozzle to help to facilitate a better coupling and to help prevent one flow from reversing into another duct.

For example, consider the engine pod of most twin-engine commercial airliners. The engine pod includes an inner nozzle containing the core flow inside a ring with the fan flow. Similarly, ejector nozzles pair one flow with another. An ejector nozzle generally creates an effective nozzle through a secondary airflow and spring-loaded petals. Per the above, any suitable nozzle design may be used, such as the generally more complex iris nozzle, and many embodiments of the present invention are neither limited to, nor excluding of, any nozzle type or design.

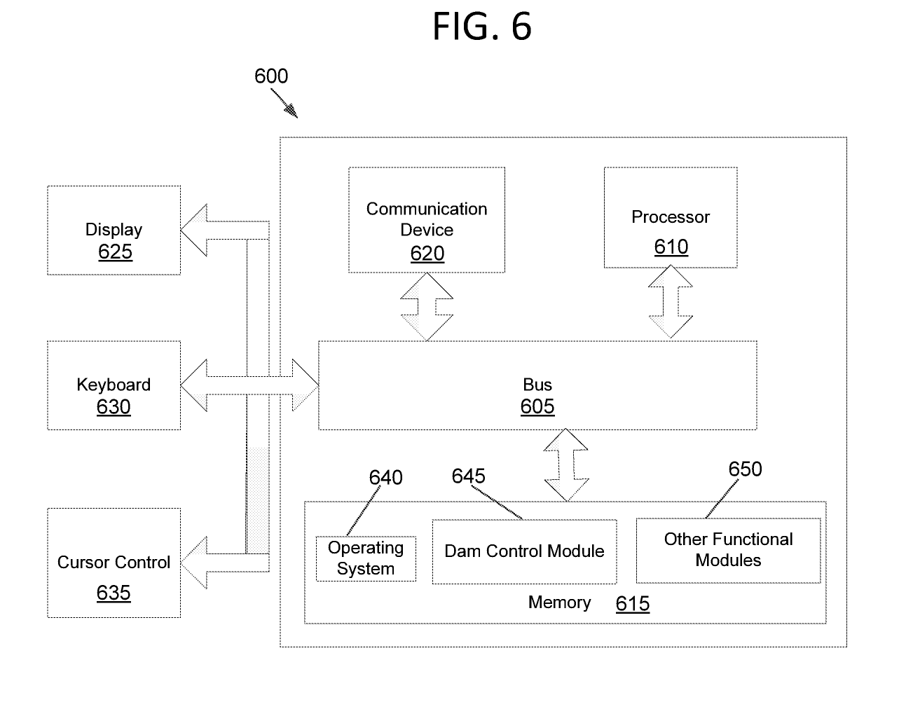

In some embodiments, the operation of various combinations of one or more heat engines and one or more water turbines that synergistically generate power in accordance with the above-described embodiments may be regulated by a controller. FIG. 6 illustrates a dam controller 600, according to some embodiments of the present invention. Dam controller 600 includes a bus 605 or other communication mechanism for communicating information, and a processor 610 coupled to bus 605 for processing information. Processor 610 may be any type of general or specific purpose processor, including a central processing unit (“CPU”) or application specific integrated circuit (“ASIC”). Dam controller 600 further includes a memory 615 for storing information and instructions to be executed by processor 610. Memory 615 can be comprised of any combination of random access memory (“RAM”), read only memory (“ROM”), flash memory, cache, static storage such as a magnetic or optical disk, or any other types of computer-readable media or combination thereof. Additionally, dam controller 600 includes a communication device 620, such as a network interface card, to provide access to a network. Therefore, a user may interface with dam controller 600 directly, or remotely through a network or any other method.

Computer-readable media may be any available media that can be accessed by processor 610 and may include both volatile and non-volatile media, removable and non-removable media, and communication media. Communication media may include computer readable instructions, data structures, program modules or other data in a modulated data signal such as a carrier wave or other transport mechanism and includes any information delivery media.

Processor 610 is further coupled via bus 605 to a display 625, such as a Liquid Crystal Display (“LCD”), for displaying information, such as dam operation status information, to a user, such as server status information. A keyboard 630 and a cursor control device 635, such as a computer mouse, are further coupled to bus 605 to enable a user to interface with dam controller 600.

In one embodiment, memory 615 stores software modules that provide functionality when executed by processor 610. The modules include an operating system 640 that provides operating system functionality for dam controller 600. The modules further include a dam control module 645 that is configured to control the operation of at least one heat engine and at least one water turbine in the dam. Dam control module 645 may speed up, slow down, or completely stop the operation of each heat engine and water turbine in the dam system. Dam control module 645 may also regulate water flow in the dam by manipulating various gates in the dam system. Dam controller 600 may be part of a larger system such as a cluster computing system, a distributed computing system, a cloud computing system, a “server farm” or any other system having multiple servers and/or computing devices. Dam controller 600 will typically include one or more additional functional modules 650 to include additional functionality. In some embodiments, dam control module 645 may be part of operating system 640 or part of one or more other functional modules included in other functional modules 650.

One skilled in the art will appreciate that a “controller” could also be embodied as a digital control console, a personal computer, a server, a console, a personal digital assistant (PDA), a cell phone, or any other suitable computing device, or combination of devices. Presenting the above-described functions as being performed by a “controller” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the controller features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

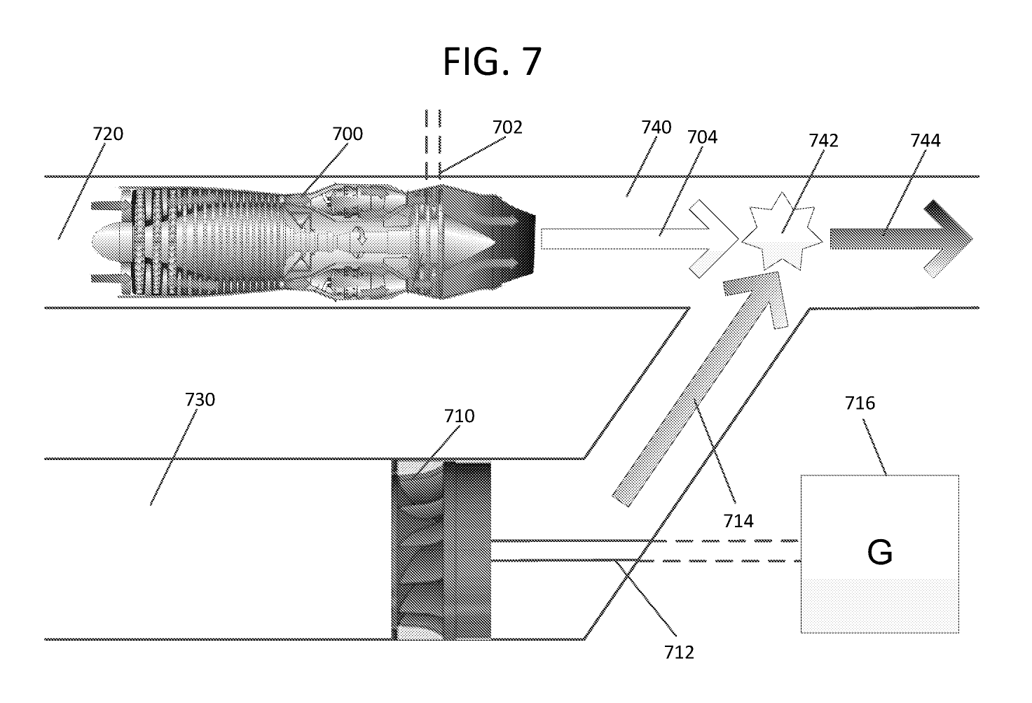

FIG. 7 illustrates a side view of a gas turbine 700 and a water turbine 710, where water turbine 710 has a horizontal shaft 712, according to some embodiments of the present invention. In FIG. 7, gas turbine 700 is supplied with air via air intake 720 and water turbine 710 is provided with flowing water via water channel 730. Gas turbine 700 may be powered by any suitable fuel, per the above. While gas turbine 700 is depicted in this embodiment, as discussed above, any suitable heat engine may be used. Water channel 730 is configured to direct a flow of water into an exit channel 740. Rotation of the turbine in gas turbine 700 causes the rotation of shaft 702, which drives a generator (not shown). Similarly, rotation of water turbine 710 causes the rotation of shaft 712, which drives a generator 716.

Exhaust gases 704 from gas turbine 700 and water 714 that passed through water turbine 710 are driven into exit channel 740, which is configured to receive both a flow of water and a flow of exhaust gases. There, exhaust gases 704 from gas turbine 700 and water 714 meet at intersection 742. The faster moving exhaust gases 704 pull the water, decreasing pressure in exit channel 740 and forming a combined gas/water stream 744. This decreased pressure causes the system to behave as though the head were higher than it mechanically is by simulating a lower exit.

A water intake (not shown) is operably connected to water channel 730 and provides water to water channel 730 from a dammed water supply. The faster flow through water channel 730 due to lower pressure in exit channel 740 causes water turbine 710 to rotate more quickly than water turbine 710 would with water flow that is unaided by gas turbine 700.

In some embodiments, gas turbine 700 can be operated alone, water turbine 710 can be operated alone, or gas turbine 700 and water turbine 710 can be operated simultaneously in order to provide a power output that is desirable at a given time from the system. This operation may be achieved by a dam controller, such as the dam controller illustrated in FIG. 6. As discussed above, the dam controller may be configured to speed up, slow down, or completely stop the operation of one or more of gas turbine 700 and water turbine 710 so that a desired power output can be achieved.

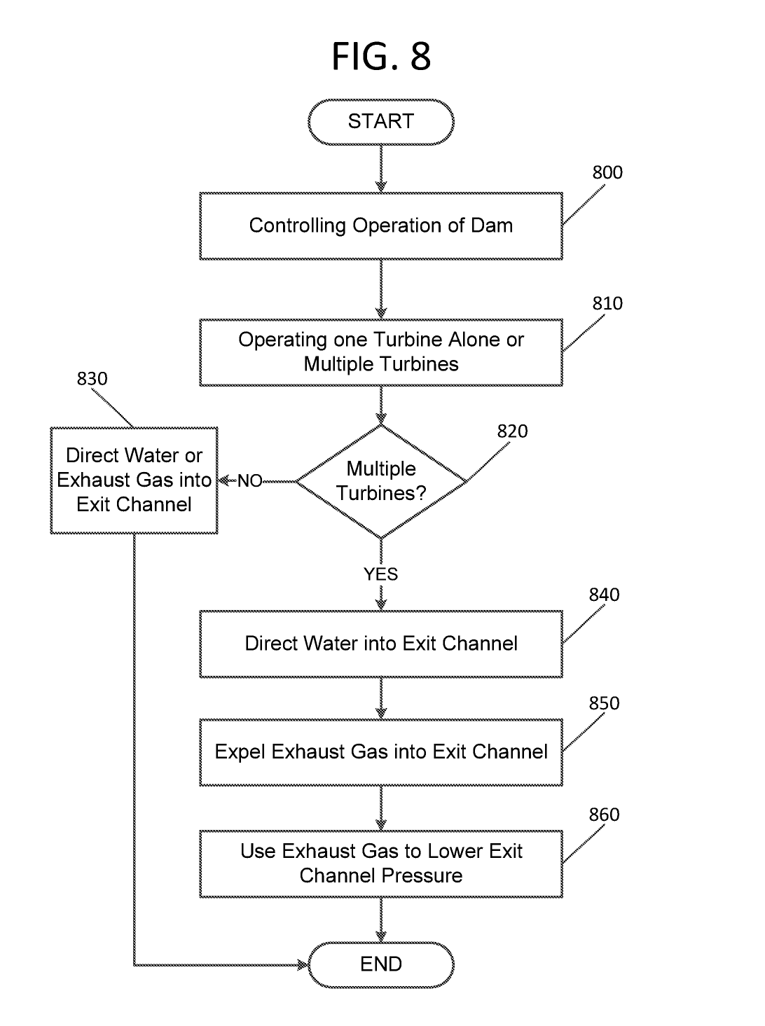

FIG. 8 illustrates a flow diagram of a method for combining a heat engine and a water turbine, according to some embodiments of the present invention. In some embodiments, the method of FIG. 8 may be performed, for example, by the systems illustrated in FIGS. 1, 3 and 7. The method begins by controlling the operation of the dam at 800 via a dam controller by speeding up, slowing down, or completely stopping the operation of one or more of the heat engine and the water turbine so that a desired power output can be achieved. Based on the settings of the dam controller at 800, the heat engine is operated alone, the water turbine is operated alone, or the heat engine and the water turbine are operated simultaneously at 810 in order to adapt to the power output that is desirable at a given time from the dam. If multiple turbines are not being operated at 820, water or exhaust gas, depending on whether the water turbine or the heat engine is being run, are driven into an exit channel at 830. The process then ends.

However, if multiple turbines are being operated, water passing through a water turbine is directed via a water channel into an exit channel at 840. The water channel converges with the exit channel. Exhaust gases from the heat engine are expelled into the exit channel at 850. The exhaust gases from the heat engine are used to pull the water, decreasing pressure in the exit channel and accelerating the flow of water out of the water channel and through the exit channel at 860. This causes the pressure of water entering a water intake that feeds the water turbine via the water channel to increase. The increased water pressure of water entering the water intake causes the dam to act as though a head of dammed water were higher than the head mechanically is. The process then ends.

Some embodiments of the present invention combine the operation of a heat engine and a water turbine in a dam system to produce advantageous synergies that may be beneficial over existing power systems. High speed, high temperature exhaust gases from a heat engine and water flowing from a water channel housing a water turbine are both driven into an exit channel. The exhaust gases and the water flow meet in the exit channel and the high speed of the exhaust gases pull the water, lowering the pressure of the exit channel and accelerating the speed of the water flow.

Due at least in part to the Bernoulli principle, the Coanda effect, and entrainment of the water flow due to viscous forces, the lower pressure causes the dam system to behave as though the head of the dammed water is greater than it mechanically is. As such, embodiments of the present invention may increase the power of existing dams or make dams economical on sites where they are currently not economical or only marginally economical.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A system, comprising:
an exit channel configured to receive a flow of water and a flow of exhaust gases;
a water channel configured to direct the flow of water into the exit channel; and
a heat engine configured to expel high velocity exhaust gases into the exit channel, wherein
the system is configured so the exhaust gases from the heat engine pull the water, decreasing a pressure of the exit channel.

2. The system of claim 1, further comprising:
a water turbine located in the water channel; and
a water intake operably connected to the water channel that is configured to provide water to the water channel from a dammed water supply, wherein
the decreased pressure in the exit channel accelerates water flowing into the water intake and through the water channel, causing the water turbine located in the water channel to rotate more quickly than the water turbine would with water flow that is unaided by the heat engine.

3. The system of claim 2, further comprising:
at least one additional heat engine, at least one additional water turbine, or both at least one additional heat engine and at least one additional water turbine.

4. The system of claim 1, wherein a fuel provided to the heat engine is selected from the group consisting of combustible gases, combustible liquids, sufficiently-pulverized coal, biomass, slurries, suspensions, radioisotopes, solar absorbers, and geothermal transfer fluids.

5. The system of claim 1, wherein the heat engine is operated alone, the water turbine is operated alone, or the heat engine and the water turbine are operated simultaneously in order to adapt to a power output that is desirable at a given time from the system.

6. The system of claim 1, wherein the heat engine comprises a gas turbine.

7. The system of claim 1, further comprising:
a dam controller configured to speed up, slow down, or completely stop operation of one or more of the heat engine and the water turbine so that a desired power output can be achieved.

8. A system for generating power in a dam, comprising:
an exit channel configured to receive a flow of water and a flow of exhaust gases;
a water turbine configured to be rotated by a flow of water through a penstock, wherein the penstock is supplied with water by a water intake and the penstock is configured to direct the water into the exit channel; and
a heat engine configured to expel high velocity exhaust gases into the exit channel, wherein
the system is configured so the exhaust gases from the heat engine pull the water, decreasing a pressure of the exit channel, and
the decreased pressure causes the dam to act as though a head of dammed water were higher than the head mechanically is.

9. The system of claim 8, further comprising:
at least one additional heat engine, at least one additional water turbine, or both at least one additional heat engine and at least one additional water turbine.

10. The system of claim 8, wherein a fuel provided to the heat engine is selected from the group consisting of combustible gases, combustible liquids, sufficiently-pulverized coal, biomass, slurries, suspensions, radioisotopes, solar absorbers, and geothermal transfer fluids.

11. The system of claim 8, wherein the heat engine is operated alone, the water turbine is operated alone, or the heat engine and the water turbine are operated simultaneously in order to adapt to a power output that is desirable at a given time from the dam.

12. The system of claim 8, wherein the heat engine comprises a gas turbine.

13. The system of claim 8, further comprising:
a dam controller configured to speed up, slow down, or completely stop operation of one or more of the heat engine and the water turbine so that a desired power output can be achieved.

14. A method of generating power in a dam, comprising:
directing water passing through a water channel into an exit channel, the water channel converging with the exit channel;
expelling exhaust gases from a heat engine into the exit channel; and
using the exhaust gases from the heat engine to pull the water, decreasing a pressure of the exit channel, wherein
the decreased pressure causes the dam to act as though a head of dammed water were higher than the head mechanically is.

15. The method of claim 14, wherein at least one additional heat engine, at least one additional water turbine, or both at least one additional heat engine and at least one additional water turbine are used.

16. The method of claim 14, wherein a fuel provided to the heat engine is selected from the group consisting of combustible gases, combustible liquids, sufficiently-pulverized coal, biomass, slurries, suspensions, radioisotopes, solar absorbers, and geothermal transfer fluids.

17. The method of claim 14, further comprising:
operating the heat engine alone, operating the water turbine alone, or operating the heat engine and the water turbine simultaneously in order to adapt to a power output that is desirable at a given time from the dam.

18. The method of claim 14, wherein the heat engine comprises a gas turbine.

19. The method of claim 14, further comprising:
controlling operation of the dam via a dam controller by speeding up, slowing down, or completely stopping the operation of one or more of the heat engine and the water turbine so that a desired power output can be achieved.
